(19) United States
(12) Patent Application Publication
(10) Pub. No.: US 2006/0124397 A1
(43) Pub. Date: Jun. 15, 2006

(54) Stepladder leg latches

(76) Inventor: Finn Vosbein-Jensen, Grass Lake, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/299,919

(22) Filed: Dec. 12, 2005

Related U.S. Application Data
(60) Provisional application No. 60/635,374, filed on Dec. 10, 2004.

(51) Int. Cl. E06C 1/00

(52) U.S. Cl. 182/165

(57) ABSTRACT

Latches are used to secure the legs of a stepladder during transport or while the ladder is leaned up against a wall or other surface. Embodiments for both extruded and solid-leg ladders are disclosed. A latch according to the invention includes a first latch portion mounted to one of the legs of the stepladder, and a second latch portion hingedly affixed to the first latch portion. In an unlatched state, the second portion is folded out of the way, enabling the stepladder to be used as a stepladder, and in a latched state, the second portion folded onto the other leg of the stepladder to hold the two legs together. A method according to the invention of latching the legs of a stepladder having a set of front legs with steps spanning right and left inside portions and a set of back legs also right and left inside portions, comprises the steps of: providing a latch with first and second hinged portions, fastening the first portion to the inside portion of one of the front legs between tow of the steps, and folding the second portion on onto one of the back legs so that the legs are latched together.

### REFERENCE TO RELATED APPLICATIONS

This application claims priority from U.S. Provisional Patent Application Ser. No. 60/635,374, filed Dec. 10, 2004, the entire content of which is incorporated herein by reference.

### FIELD OF THE INVENTION

This invention relates generally to ladder accessories, and, in particular, to a device for holding the legs of a stepladder together so that it may be more easily leaned up against a wall or other surface.

### BACKGROUND OF THE INVENTION

A typical stepladder, illustrated in FIG. 1A at 102, includes front legs 104 terminating in floor pad 106, back legs 108 terminating in floor pads 110, a top platform 112 and a stabilizing hinge 114. The back legs 108 are generally shorter than the front legs 104. On occasion, users of stepladders desire to lean the ladder up against a wall 120, as shown in FIG. 1B. This does not create a problem if the legs remain together; however, even with hinges 114, the legs spread apart. When this happens, the back legs 108 hit the floor 122, creating a potential stability problem.

U.S. Pat. No. 6,145,620 resides in a height adjustable work support assembly to be used primarily as an integral part of a stepladder. It includes a work support tube with interchangeable platform bases. The work support tube extends downward through the top of the ladder, and is held in position and guided by a pivoting lock plate attached to the top of the ladder by a supporting plate. A pivoting guide bushing assembly located at a lower level, supports the tube in the vertical position. The lock plate and guide bushing assembly can be pivoted upward/downward with the closing of the ladder, permitting the work support tube to be pivoted and held within the confines of the folded ladder. When the work support tube is pivoted, the spring loaded locking washer locks the work support tube in the reverse direction, preventing it from sliding out of the ladder while storing or transporting.

Despite apparatus of the types just described, the need remains for a device which may be used to at least temporarily hold the legs of a stepladder together, so that it may be more easily placed against a wall or other surface, eliminate “racking,” and facilitate easier storage.

### SUMMARY OF THE INVENTION

This invention improves upon the existing art by providing a latch that may be secured to one leg of a stepladder, including a hinged portion to engage with the other leg of the stepladder, thereby holding the legs together temporarily while the ladder is leaned up against a wall or other surface. Embodiments for both extruded and solid-leg ladders are disclosed.

A latch according to the invention includes a first latch portion mounted to one of the legs of the stepladder, and a second latch portion hingedly affixed to the first latch portion. In an unlatched state, the second portion is folded out of the way, enabling the stepladder to be used as a stepladder, and in a latched state, the second portion folded onto the other leg of the stepladder to hold the two legs together.

A method according to the invention of latching the legs of a stepladder having a set of front legs with steps spanning right and left inside portions and a set of back legs also right and left inside portions, comprises the steps of: providing a latch with first and second hinged portions, fastening the first portion to the inside portion of one of the front legs between tow of the steps, and folding the second portion on onto one of the back legs so that the legs are latched together.

### BRIEF DESCRIPTION OF THE DRAWINGS

FIG. 1A is side-view drawing of a typical stepladder;

FIG. 1B is side-view drawing of a stepladder leaned up against a wall;

FIG. 1C is side-view drawing showing how the back legs of a stepladder can interfere with a floor surface when leaned up against a wall;

FIG. 2 is a drawing which shows a ladder leaned up against a wall utilizing a device according to this invention;

FIG. 3A is a cross-sectional view of a preferred embodiment of the invention in an unlatched condition;

FIG. 3B is a cross-sectional view of a preferred embodiment of the invention in a latched condition;

FIG. 4A is an oblique view of a preferred embodiment of the invention in an unlatched condition;

FIG. 4B is an oblique view of a preferred embodiment of the invention as the latch is moved into position;

FIG. 4C is an oblique view of a preferred embodiment of the invention in a latched condition;

FIG. 5 is a cross-sectional view of an alternative embodiment of the invention adapted for use with solid-leg ladders;

FIG. 6 is an oblique view of an alternative embodiment of the invention with stacked hinge portions affording a lower profile in an unlatched state;

FIG. 7A is a drawing of an alternative embodiment of the invention in the form of a lever-activated leg latch;

FIG. 7B shows the embodiment of FIG. 7A in an unlatched state;

FIG. 7C shows the embodiment of FIG. 7A in an unlatched state;

FIG. 8A shows an alternative lever-activated embodiment in an unlatched state; and

FIG. 8B shows an alternative lever-activated embodiment in a latched state.

### DETAILED DESCRIPTION OF THE INVENTION

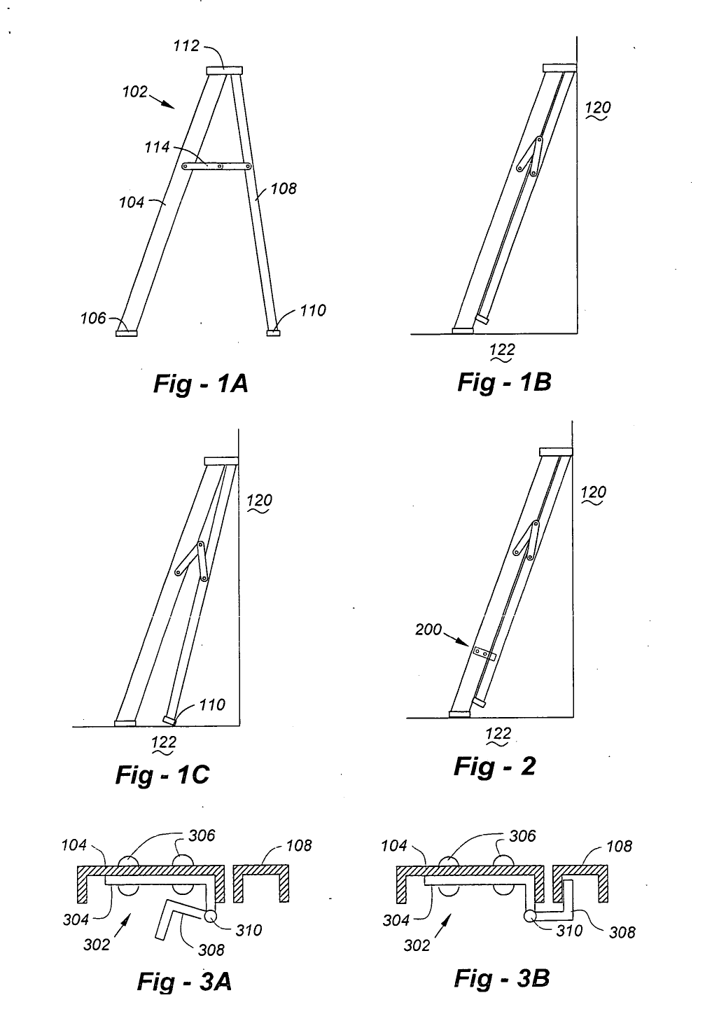

Turning now to the drawings and having discussed FIG. 1, FIG. 2 shows, from a side-view perspective, a stepladder leaned up against a wall, with a latch 200 according to the invention used to hold the two legs of the ladder together, as will be described in greater detail with respect to the preferred and alternative embodiments. Although two latches according to the invention may be provided, one on either side of the ladder, only a single latch is actually required. In terms of construction, the latches according to this invention are preferably made from steel or other metal, such as galvanized plate steel having a thickness in the range of one-sixteenth to one-quarter of an inch. The device is preferably mounted between steps, usually at a height of 12″ to 36″ from the bottom of the front legs, depending upon the overall height of the ladder.

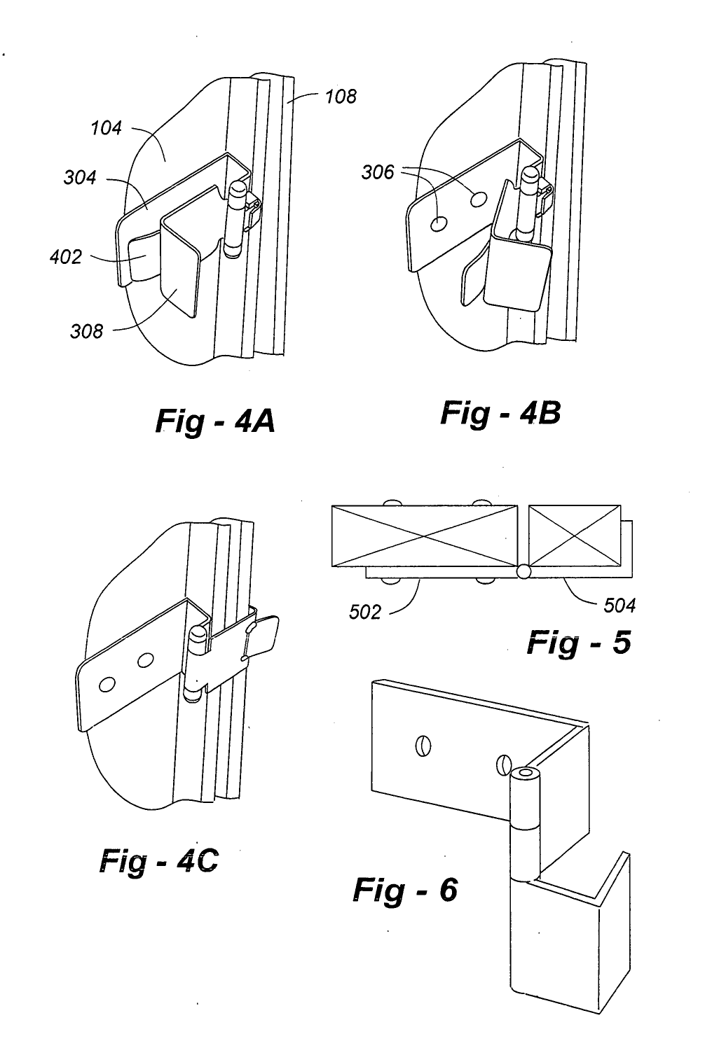

FIG. 3A is a cross-sectional view of a latch 302 according to the invention in an unlatched state for use with extruded ladder legs. A first portion of the latch, 304, is mounted against the longer leg 104 of the ladder, through mounting holes. Latches according to the invention may either by provided by the manufacturer, in which case fasteners such as rivets may be used, or may be provided as an after-market device, requiring a purchaser to drill holes and install the first portion 304 with nuts and bolts, ‘pop’ rivets or other suitable fasteners. FIG. 3B shows the latch in a latched condition, with the second portion 308, hinged at 310, latching the shorter or back leg 108 of the ladder. FIGS. 4A through 4C show the process of latching from an oblique perspective. Note that the hinge 310 is preferably of the spring-loaded locking variety. Also an optional tab 402 may be provided for more convenient operation.

The invention may be configured for any type of ladder through appropriate engineering appreciated by those of skill in the art. For example, FIG. 5 illustrates an embodiment of the invention suitable for holding together the legs of a solid ladder, which might be constructed from wood, fiberglass or plastic. Again, the latch includes a first portion 502, mounted on the longer leg of the ladder, and a second portion 504, hingedly attached thereto.

FIG. 6 is an oblique view of an alternative embodiment of the invention with stacked hinge portions affording a lower profile in an unlatched state. Here, the first portion of the latch L-shaped to fit into the U-shaped surface of a typical extruded aluminum or fiberglass ladder, with a second portion of the latch also being L-shaped so that they lay side-by-side when completely unlatched.

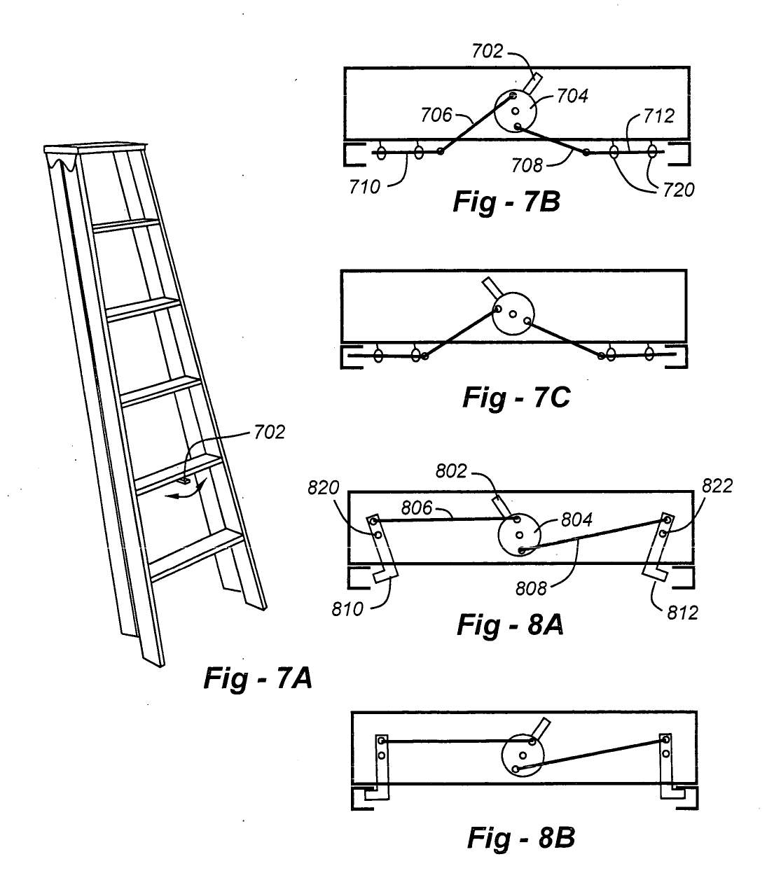

FIG. 7A is a drawing of an alternative embodiment of the invention in the form of a leg latch activated by a lever 702. The lever 702 is coupled to a plate 704 which, in turn, is coupled to link members 706, 708. The link members 706, 708 are coupled to engagement members 710, 712 through guides 720. FIG. 7B shows the embodiment of FIG. 7A in an unlatched state, while FIG. 7C shows the embodiment of FIG. 7A in an unlatched state. FIG. 8A shows an alternative lever-activated embodiment in an unlatched state. The lever 802 is coupled to a plate 804 which, in turn, is coupled to link members 806, 808. The link members 806, 808 are coupled to engagement members 810, 812 which pivot at points 820, 822. FIG. 8B shows an alternative lever-activated embodiment in a latched state.

I claim:

1. A latch for holding the legs of a stepladder together so that it may be more easily leaned up against a wall or other surface, comprising:
a first latch portion mounted to one of the legs of the stepladder; and
a second latch portion hingedly affixed to the first latch portion, having a first state where it is folded out of the way, enabling the stepladder to be used as a stepladder, and a second state where it is folded onto the other leg of the stepladder to hold the two legs together.

2. The latch of claim 1, wherein at least the first latch portion is L-shaped to fit into an extruded ladder leg.

3. The latch of claim 1, adapted for use with solid-leg ladders.

4. A ladder assembly, comprising:
a stepladder having a longer leg and a shorter leg; and
a latch operative to hold the two legs together, to make it easier to lean the ladder up against a wall or other surface.

5. The system of claim 4, wherein the ladder is an extruded aluminum ladder.

6. The system of claim 4, wherein the ladder is a solid-leg ladder.

7. A method of latching the legs of a stepladder having a set of front legs with steps spanning right and left inside portions and a set of back legs also right and left inside portions, comprising the steps of:
providing a latch with first and second hinged portions:
fastening the first portion to the inside portion of one of the front legs between tow of the steps; and
folding the second portion on onto one of the back legs so that the legs are latched together.
